(19) United States
(12) Patent Application Publication
(10) Pub. No.: US 2011/0174344 A1
(43) Pub. Date: Jul. 21, 2011

(54) WASHING AGENT DISPENSER FOR A WASHING MACHINE

(75) Inventors: Daniele Cerruti, Caresana (IT); Costanzo Gadini, Frassineto Po (IT)

(73) Assignee: ELTEK S.P.A., Casale Monferrato (AL) (IT)

(21) Appl. No.: 13/056,959

(22) PCT Filed: Jul. 29, 2009
(86) PCT No.: PCT/IB2009/006395

§ 371 Date: Apr. 5, 2011

(30) Foreign Application Priority Data
Aug. 1, 2008 (IT) TO2008A000609

(51) Int. Cl. B08B 3/00; B67D 7/16

(52) U.S. Cl. 134/115 R; 222/71; 222/1

(57) ABSTRACT

A dispenser for washing agents, in particular of the type adapted to dispense a washing agent into a tub of a washing machine, includes at least one casing that has at least one reservoir for washing agents and a metering element provided with at least one movable chamber. The movable chamber can be moved between a first and a second position respectively corresponding to a supply condition, wherein washing agents are supplied from the reservoir into the movable chamber, and a discharge condition, wherein the washing agents are discharged from the movable chamber into the tub. The dispenser includes structure provided with at least one sliding surface adapted to facilitate the supply and/or discharge of the washing agents.

The present invention relates to a washing agent dispenser for a washing machine, such as a dishwasher, in particular according to at least the preamble of claim 1, and to a method for supplying and discharging a washing agent through a dispenser, in particular according to at least the preamble of claim 15.

As known, washing machines, in particular household washing machines such as dishwashers, are normally equipped with a dispenser for washing agents, e.g. powder, liquid, solid or tablet detergents or additives, which are released into the wash tub of the machine during the various wash steps.

As far as dishwashers are concerned, washing agents typically include detergent and/or rinse aid contained in respective reservoirs in communication with respective dispensers, which during the wash cycle meters and supplies at least one dose of washing agent into the wash tub.

The capacity of the reservoirs of some dispensers, called bulk or multi-dose dispensers, is such as to allow for a plurality of distributions during multiple machine operating cycles, so that the user no longer has to refill the reservoir before each wash cycle; in addition to supplying the washing agent into the wash tub, these dispensers also provide the washing agent metering function.

Dispensers also exist which lack a bulk reservoir, being equipped with a compartment containing just one dose of washing agent, which the user must load before each machine operating cycle.

Other dispensers comprise both a bulk or multi-dose dispenser, e.g. for rinse aid, and a single-dose dispenser, e.g. for detergent.

In another known type of bulk or multi-dose dispenser, the washing agent metering and release operations are carried out by a metering piston moving within a dispenser casing, just like a piston sliding in a cylinder, thereby defining a movable chamber moving between a position wherein it is in communication with the reservoir and another position wherein it is in communication with the tub; the movable chamber is therefore defined by perimetric or peripheral walls, some fixed and some movable (i.e. associated with the piston), so that it can be moved between a supply position and a discharge position.

In general, when these devices are set to the operating condition for discharging the washing agent, they are arranged on a vertical wall of the machine or on a pivoted door thereof, which when the machine is in the operating condition is positioned vertically; in this condition, the movable chamber is typically lower than the reservoir, thus allowing the washing agent to flow from the latter to the former, preferably by gravity.

The metering piston is driven by a dedicated actuator, so as to put the movable chamber in communication with the reservoir and the tub, respectively through an inlet and a discharge provided on the cylinder consisting of the dispenser casing, in which the metering piston can slide.

One common feature of this known type of dispenser is that the size and shape of the inlet and discharge are substantially equal or close to those of the movable chamber section defined by the metering element, so that during the supply and discharge steps the movable chamber completely or prevalently abuts on or matches, respectively, said inlet and discharge towards both the reservoir and the tub (or the duct leading to the reservoir and the tub); the opening of the chamber for the supply or discharge steps, in fact, affects an entire perimetric wall of the chamber, e.g. the upper or top wall and/or the lower or bottom wall.

For this purpose, the stroke of the actuator that drives the metering piston is such as to allow said respective full positioning or matching, i.e. the actuator stroke substantially matches the length of the supply port and/or discharge port and/or movable chamber, with reference to the direction of travel.

This requirement derives from the need of filling and/or discharging the chamber completely: the movable chamber translates horizontally between two positions, i.e. a supply position and a discharge position: in the former position, the chamber loses the whole top wall, so that its full volume faces the reservoir (or a duct afferent thereto), whereas in the latter position the chamber loses the whole bottom wall, so that its entire volume faces the tub (or a duct afferent thereto); the horizontal translation of the movable chamber is controlled by the actuator, which is for this purpose provided with a horizontal drive shaft.

This implies a drawback due to the dispenser being necessarily very large: as a matter of fact, given the geometry and kinematics described above, the total volume and horizontal dimension are more than double those of the movable chamber. This drawback is felt even more when large doses of washing agents are to be supplied, since such a case requires a high-volume movable chamber, and hence (in accordance with the above-described geometry) a long-stroke actuator or a very high or wide chamber, resulting in even more space taken up on the vertical wall of the washing machine.

However, the use of a long-stroke actuator, e.g. having a linear stroke of a few centimetres, has considerable drawbacks, such as high cost, large dimensions or excessively low forces.

In some of these known dispensers, which can only be used for dispensing powder washing agents, the discharge mouth is arranged on one side rather than at the bottom, and during the discharge step the chamber loses an entire perimetric or peripheral wall; such dispensers are equipped with a pump or blower that generates a compressed air flow adapted to facilitate the discharge operation and/or to create a slight overpressure within the reservoir and the chamber, so that the powder washing agent is discharged through the joint action of gravity and air flow:

Although it offers a few advantages, this known solution is relatively complex and does not appear to be appropriate for dispensing liquid washing agents which, also due to said overpressure, might seep through the mating surfaces between the metering and/or distributing element and the dispenser casing wherein said element is movable, which typically lack any gaskets or are provided with complex sealing elements.

In this regard, a further drawback should be mentioned which relates to the fact that, since the sealing elements (made of rubber or elastomer) are generally arranged on the mating surfaces between the metering piston and the translating dispenser casing, they are normally subject to frictional wear, e.g. caused by the relative sliding of the sealing surfaces and/or by powder detergent infiltration, resulting in said sealing elements getting prematurely broken, cracked or damaged.

It is a first object of the present invention to provide a dispenser which can overcome the above-mentioned drawbacks.

It is a second object of the present invention to provide a dispenser comprising a movable chamber that translates between two positions, in which it is alternately filled with a washing agent and the latter is then discharged into the tub, and equipped with means adapted to facilitate the supply and/or discharge of the washing agents. Another object is to allow the movable chamber of a metering and/or distributing element to be completely and/or optimally filled and discharged.

A further object is to provide a linearly movable chamber having a high supply and discharge capacity while still featuring a short stroke and/or being driven by a short-stroke actuator.

Yet another object is to facilitate the supply of washing agent, so as to allow the chamber to be filled completely and/or optimally, thus ensuring a correct metering, and preferably simplifying the elimination of any stagnant air or bubbles possibly formed in the chamber during the supply step.

A further object is to facilitate the discharge of the washing agent from the chamber to the tub, in particular in a manner such that the whole dose of washing agent is dispensed properly.

It is yet another object to obtain a dispenser chamber having a predefined and fixed volume and capable of metering the same dose of washing agent at every dispensing operation, regardless of the level of the washing agent contained in the reservoir.

A further object is to provide a low-cost dispenser ensuring a perfect seal between the dispenser piston and the cylinder.

A preferred version of the present invention relates to a dispenser as described at least in the preamble of claim 1, which is intended as an integral part of the present description; likewise, a preferred version of the present invention relates to a method for supplying a washing agent into a dispenser as described in claim 15, which is intended as an integral part of the present description; further advantageous features are described in the appended claims, which are intended as integral parts of the present text.

The present invention preferably relates to bulk or multi-dose dispensers, though it is also applicable to devices comprising multiple dispensers, even of different types, such as a multi-dose dispenser associated with a single-dose dispenser.

In particular, the invention relates to a dispenser wherein the washing agent metering and release operations are carried out at least partly by a movable element or metering element or metering piston which, driven by an actuator, moves within a dispenser casing and at least partly defines a movable chamber that translates between at least one position wherein it is in communication with the reservoir or an inlet and one position wherein it is in communication with the tub or a discharge.

In this respect, it should be mentioned beforehand that in this description and in the appended claims the dispenser will be considered to be in the operating condition when positioned on the vertical wall of the washing machine or of the vertically arranged door (in substance, when the latter is preventing access to the tub); it should furthermore be noted that the dispenser may also be in the operating condition when associated with the washing machine in different positions or at different angles, as is the case of dispensers mounted on profiled or inclined portions of the dishwasher's wall, which will nonetheless still fall within the range of operating conditions according to the invention.

The present invention is based upon the idea of providing the dispenser with means having at least one sliding surface adapted to facilitate the supply and/or discharge of the washing agents; said surface is preferably one of the perimetric surfaces that delimit the chamber.

A first advantageous feature is that at least a portion of the top surface of or associated with the movable chamber is inclined relative to a substantially vertical reference direction (normally coinciding with the direction in which the washing agent drops by gravity into the chamber), so as to allow the chamber to be filled completely and ensure a correct metering, as will be described later on, while at the same time expelling any air possibly present or accumulating in the movable chamber towards the reservoir and/or the inlet; thanks to this device, both powder and liquid washing agents can take up the whole chamber volume, so that the chamber can always be filled properly and the washing agent is always metered correctly and accurately.

According to a second advantageous feature, which may be either alternative to or combined with the first one, at least a portion of the bottom surface of or associated with the movable chamber is inclined relative to a vertical direction (normally coinciding with the direction in which the washing agent drops by gravity from the chamber into the tub and/or the outlet); this feature ensures an optimal and/or complete discharge of the washing agent contained in the chamber during the discharge step.

The top and bottom surfaces of the chamber are in general to be intended in a broad sense, because the chamber may essentially have any shape: for example, it may be prismatic, cylindrical or spherical, or even have an irregular shape; in any case, the top and bottom surfaces are preferably to be intended as those which delimit at least partly the chamber at the top and at the bottom, respectively; as will be further described below, the top and bottom surfaces of the chamber may be at least partly defined by the piston, by the movable chamber or by a seat in the dispenser casing, in which said piston or chamber moves.

In short, by providing a bottom surface sloping down towards the discharge mouth or the discharge and/or a top surface rising up towards the supply mouth or the inlet, preferably gradually (i.e. with no undercuts), both the supply and discharge of the washing agent are facilitated while allowing the air contained in the movable chamber to be easily evacuated by natural lift towards the inlet or into the reservoir, especially in the case of liquid washing agents, and/or while ensuring a proper accumulation of powder washing agents, resulting in a correct metering thereof. As will be further described below, these features also allow to conceive (as an alternative thereto or in combination therewith) discharge and/or supply apertures obtained at least partly in at least one of the peripheral or perimetric walls delimiting the movable chamber.

The planimetric extension of the section of the inlet and/or discharge is smaller than that of the section of the movable chamber, so that, in the supply and/or discharge conditions, the chamber only loses a limited portion of one or more of its delimiting walls for opening the supply and/or discharge apertures in communication with the reservoir and/or tub, respectively.

More specifically, when the supply port is obtained in the chamber top surface and the discharge port is obtained in the chamber bottom surface, at least one of these ports (preferably both) has a section with a planimetric extension smaller than the longitudinal section of the movable chamber.

In other words, in the discharge condition the discharge port takes up just a portion of the chamber bottom surface, and in the supply condition the supply port takes up only a portion of the chamber top surface.

So combined, these features offer the advantage of obtaining a smaller dispenser, the chamber volume being equal: in fact, the chamber requires less movement between the supply and discharge positions and vice versa, resulting in a more compact dispenser and in a quicker actuation thereof during the supply and discharge steps; the higher speed thus obtained is most advantageous when thermal or electrothermal actuators are used, which are typically quite slow.

It is worth mentioning that these two latter features may also exist independently of each other.

Furthermore, the dispenser according to the present invention is perfectly operational whether liquid or powder washing agents are used.

According to another inventive and advantageous aspect, when the dispenser is in the operating condition or in the properly installed condition, the whole chamber has an inclined trim with respect to the washing agent drop direction, which is substantially vertical, and extends obliquely downwards in the direction from the supply port to the discharge port; such an inclined trim of the chamber or motion direction of the movable piston preferably extends obliquely or at an angle or slightly arched relative to at least one of a wall or surface of the dispenser and a wall or surface of the tub or of the door of the washing machine.

A further aspect deserving to be tackled is that at least one of the gaskets possibly employed, as will be described in detail later on, is preferably subject to compression, preferably in an axial direction or in a direction substantially coinciding with said inclined or oblique trim, thereby providing the remarkable advantage that gasket wear is eliminated or reduced, while the resistance or friction thereof against the force exerted by the actuator is reduced as well, resulting in a longer life of both the actuator and the gasket.

A variant which will be described further on offers the cost advantage of employing gaskets obtained in one piece with the piston or movable element.

These and other features and advantages of the present invention will become more apparent from the following description of a number of embodiments thereof as shown in the annexed drawings, which are only supplied by way of non-limiting example, wherein:

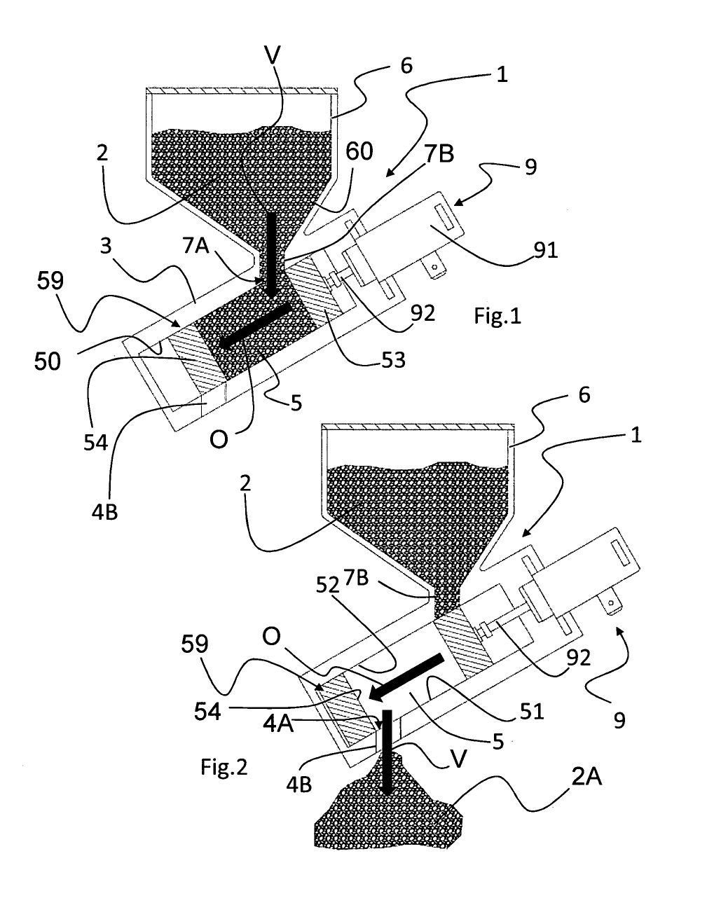

FIGS. 1 and 2 show a first version of the dispenser according to the present invention in the supply and discharge conditions, respectively;

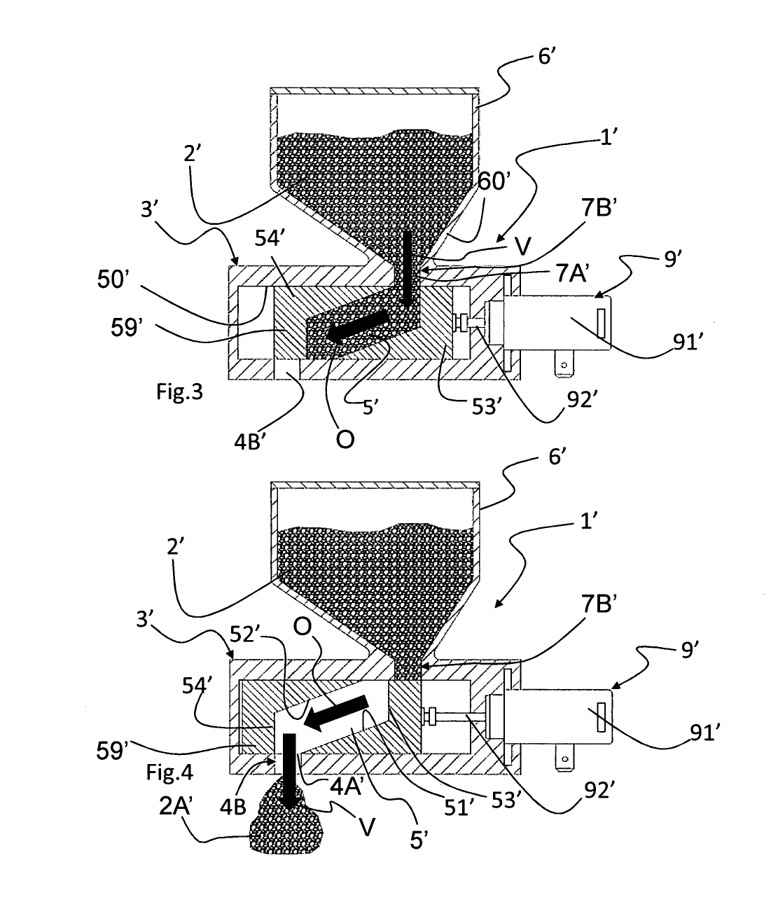

FIGS. 3 and 4 show a variant of the dispenser according to the present invention in the supply and discharge conditions, respectively;

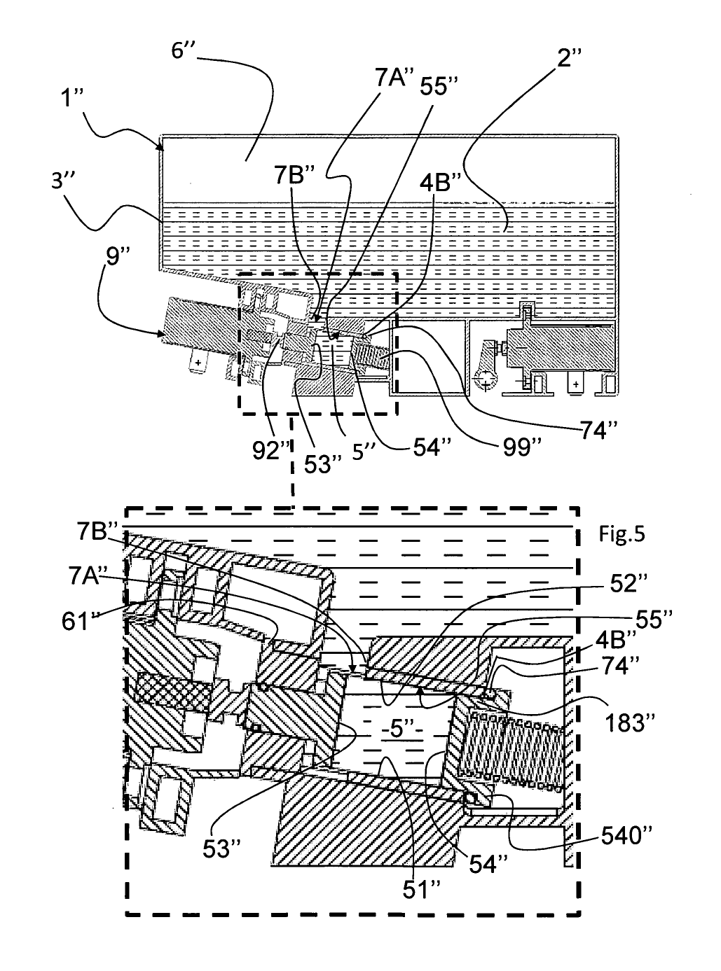

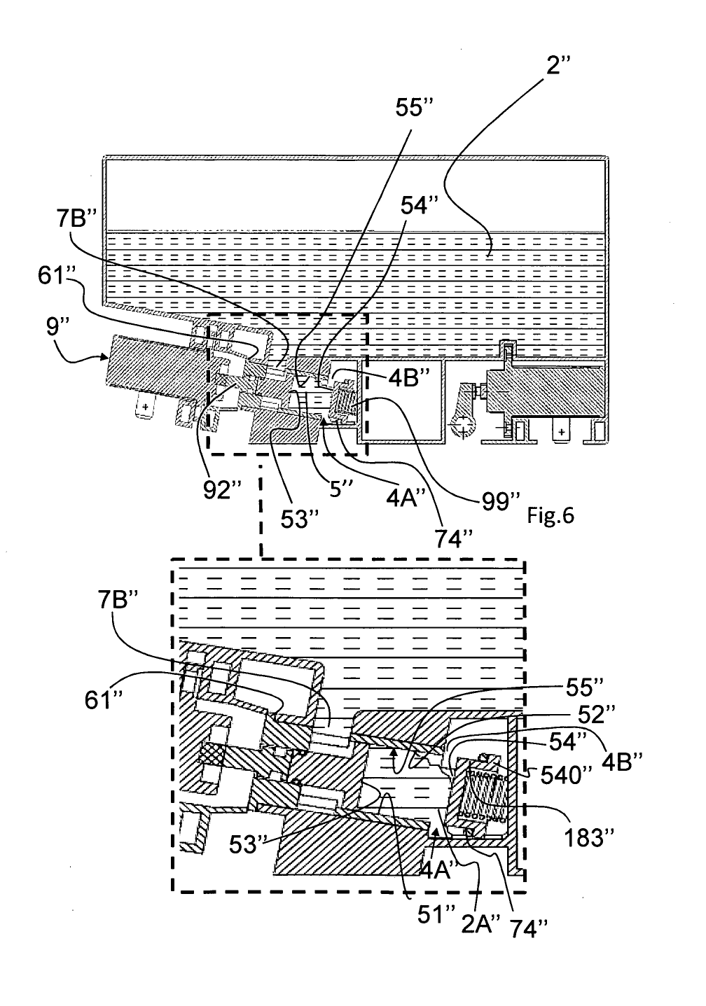

FIGS. 5 and 6 show a practical implementation and two enlarged views of the first version of the dispenser according to the present invention in the supply and discharge conditions, respectively;

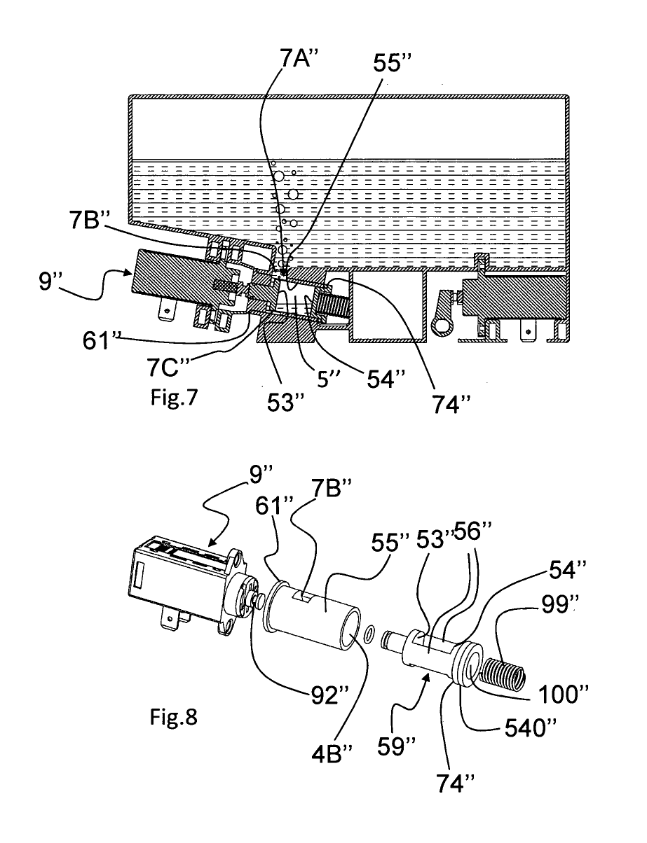

FIG. 7 shows the dispenser of FIGS. 5 and 6 in an operating condition;

FIG. 8 is an exploded view of some details of the dispenser of FIG. 7;

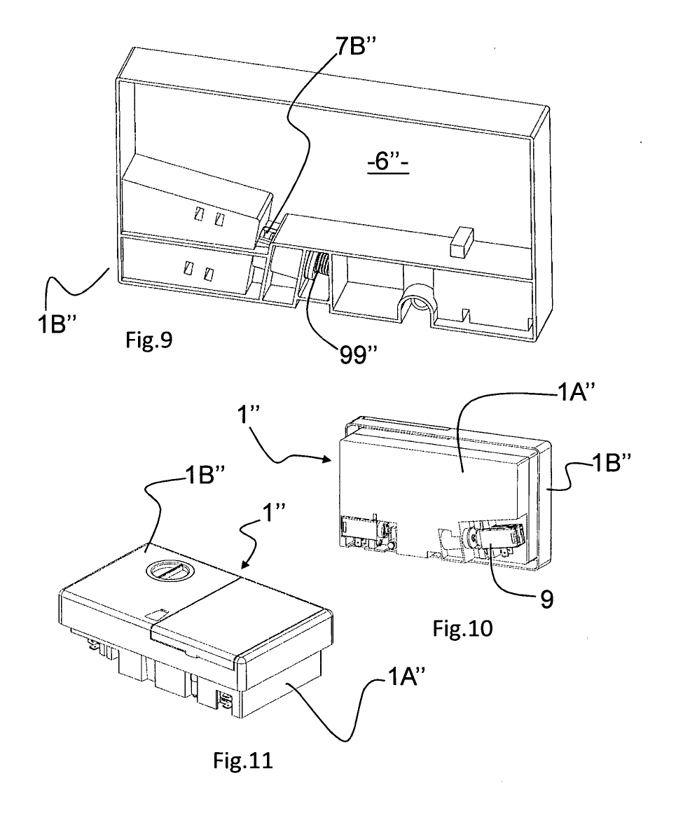

FIG. 9 is a perspective view of a part of the casing of the dispenser of FIG. 5;

FIGS. 10 and 11 are perspective rear and front views, respectively, of the dispenser of FIG. 5;

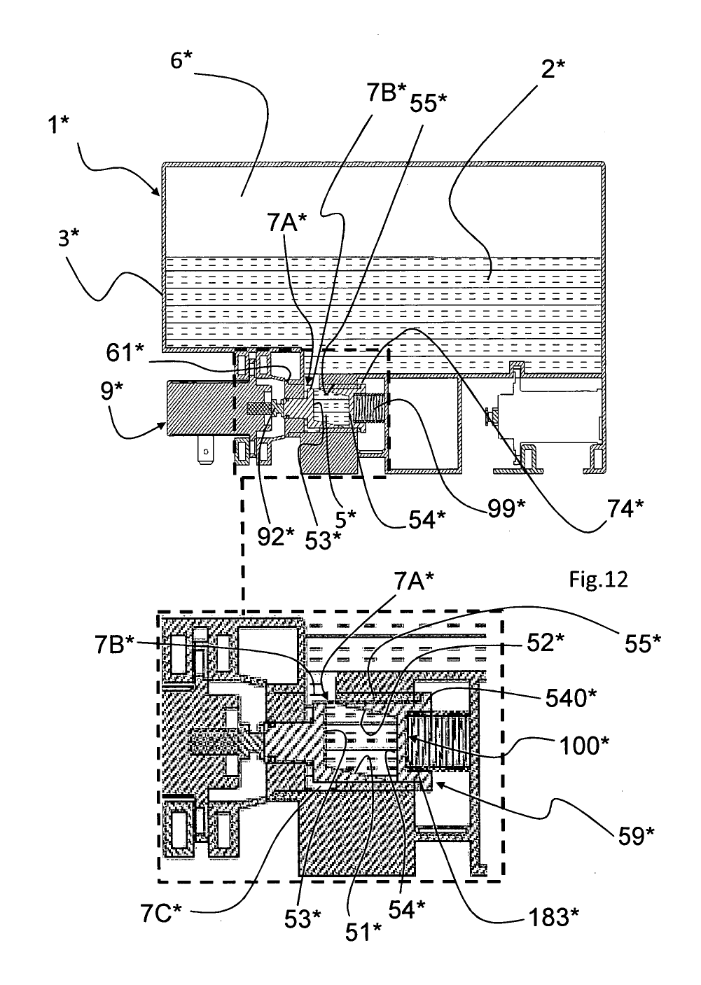

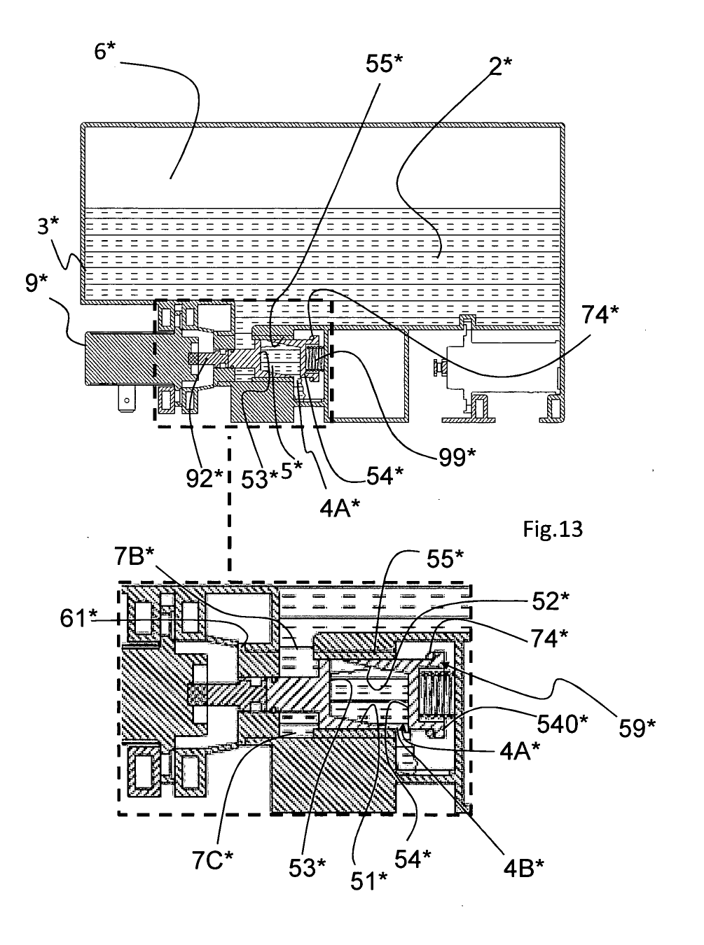

FIGS. 12 and 13 show a practical implementation and two enlarged views of the proposed variant of the dispenser according to the present invention in the supply and discharge conditions, respectively;

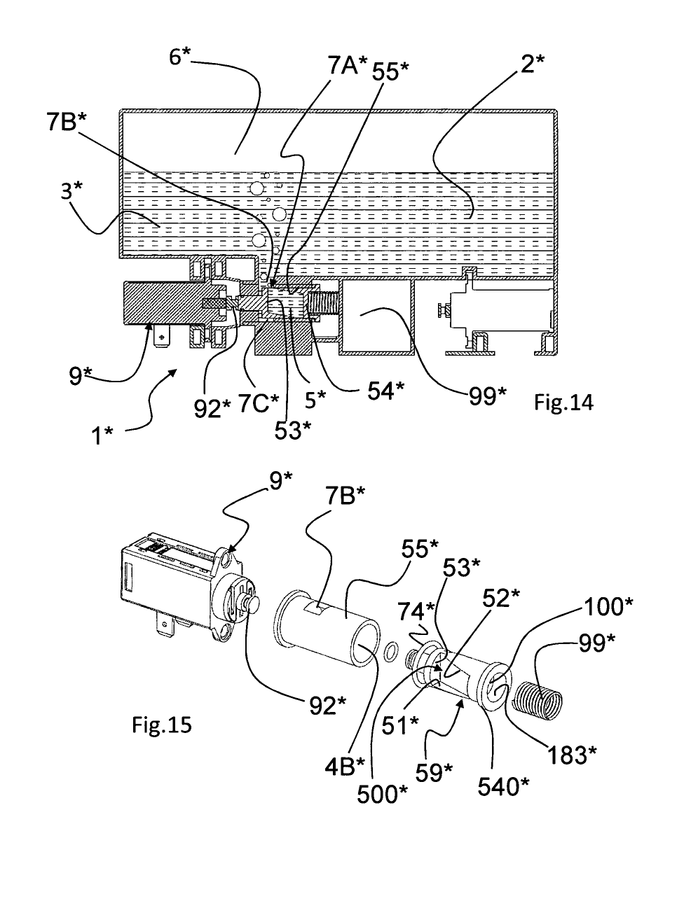

FIG. 14 shows the dispenser of FIGS. 12 and 13 in an operating condition;

FIG. 15 is an exploded view of some details of the dispenser of FIG. 14;

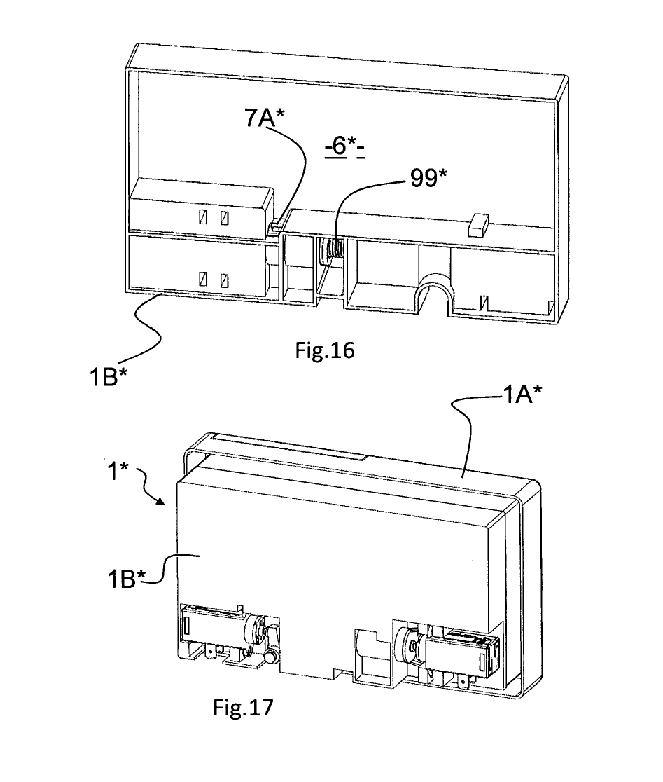

FIG. 16 is a perspective view of a part of the casing of the dispenser of FIG. 12;

FIG. 17 is a rear view of the dispenser of FIG. 12;

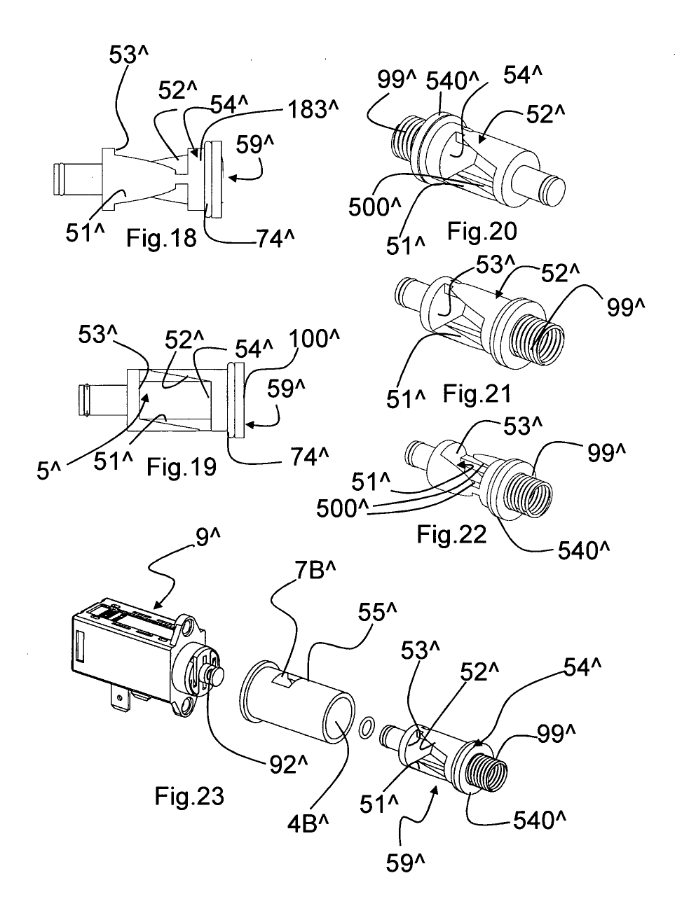

FIGS. 18 and 19 are two views turned by 90° of an alternative embodiment of the metering piston of the movable chamber;

FIGS. 20, 21 and 22 are three perspective views of the metering piston of FIGS. 18 and 19;

FIG. 23 is an exploded view of some details of a variant of the dispenser equipped with the metering piston of FIGS. 18 to 22;

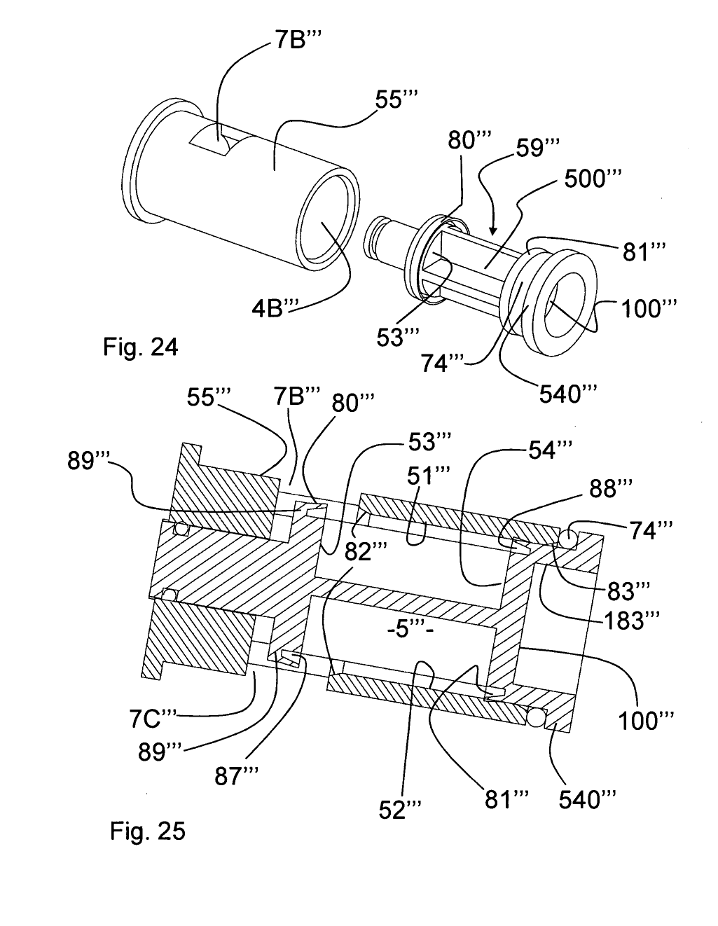

FIG. 24 is an exploded view of some components of the dispenser of FIGS. 5 and 6 according to an alternative embodiment;

FIG. 25 is a sectional view of the components of the embodiment of FIG. 24.

Prior to describing the drawings in detail, it is appropriate to specify that the features of the invention may be implemented into a dispenser in different ways, but the following will illustrate in detail two main versions, the principle of operation of which is shown in FIGS. 1 and 2 for the first version and in FIGS. 3 and 4 for the second version, while FIGS. 5 to 11 illustrate a practical implementation of the first version and FIGS. 12 to 17 illustrate a practical implementation of the second version. Referring now to FIGS. 1 and 2, there is shown a dispenser 1 for washing agents 2 according to a first embodiment.

This type of dispenser 1 is adapted to be associated with a wall of a tub of a washing machine, e.g. a vertical wall or any wall which takes a vertical position when the washing machine is in the operating condition, such as a door turning about a horizontal axis.

Dispenser 1 comprises a casing 3 having a discharge 4B afferent to the tub; it also houses a reservoir 6 that contains washing agents 2, whether liquid or powder ones, which will be fed into the machine during the various operating cycles.

Inside casing 3 of the dispenser, a metering element is provided in the exemplifying, non-limiting form of a metering piston 59, whose front 54 and rear 53 head walls, which are integral with each other, are shown in FIGS. 1 and 2: front head wall 54 is closer to discharge 4B, whereas rear head wall 53 is closer to inlet 7B located between reservoir 6 and casing 3.

Metering piston 59 at least partly defines or delimits a movable chamber 5, and moves within seat 50 defined in casing 3 of dispenser 1.

In this case, therefore, movable chamber 5 is delimited by peripheral or perimetric walls obtained partly in one piece with casing 3 and partly in one piece with metering piston 59.

During the step in which the washing agent is supplied from reservoir 6 (shown in FIG. 1), movable chamber 5 is placed in communication with the latter through supply aperture 7A matching inlet 7B at the end of funnel-like mouth 60 of reservoir 6.

FIGS. 1 and 2 show funnel-like mouth 60 afferent to inlet 7B, which are however to be considered as non-limiting examples: in fact, the inlet may also be provided in different forms, so long as it is adapted to convey the washing agent from reservoir 6 to chamber 5 according to the principle of operation of the dispenser, which is mainly based on the washing agent dropping by gravity in the drop direction, designated by downward-pointed arrow V.

Likewise, discharge 4B may also be provided in different forms, so long as it is adapted to convey the washing agent from chamber 5 to the tub, preferably by gravity.

In the following description, reference will also be made to an oblique or inclined direction O to be intended relative to vertical direction V, which is the direction of drop by gravity of the washing agents with the dispenser mounted in its operating condition: the term “oblique” or “inclined” refers to a direction which is not perpendicular (when projected onto the same sectional plane) to vertical reference direction V.

As an alternative, direction O may also define a curved or slightly arched trajectory. During the discharge step (shown in FIG. 2), movable chamber 5 is placed in communication with the tub through discharge aperture 4A, which is formed when moving front wall 54 exposes discharge 4B, thereby allowing washing agent 2A to be delivered to the tub.

According to the invention, the means adapted to facilitate the supply of the washing agents comprise at least an inclined portion of top surface 52 of movable chamber 5, said inclined portion being oriented towards inlet 7B in direction O so as to facilitate the supply of washing agents 2 while at the same time expelling the air contained in movable chamber 5 easily, since it will tend to come out from chamber 5 in the supply condition by flowing up towards the highest point of chamber 5 without encountering any obstacles and then into supply aperture 7A that matches inlet 7B, to finally reach reservoir 6.

In accordance with further teachings of the present invention, the means adapted to facilitate the discharge of the washing agents comprise at least an inclined portion of bottom surface 51 of movable chamber 5, said inclined portion being oriented in direction O (essentially corresponding to the direction in which washing agent 2 slides towards discharge aperture 4A), i.e. towards discharge 4B provided in casing 3 of dispenser 1, so as to convey the washing agent towards the tub during the discharge step by allowing it to slide or glide or flow on the inclined portion of said bottom surface 51.

In this first embodiment, at least movable chamber 5 defined by piston 59 and preferably also the head walls 53 and 54 are inclined, so that bottom surface 51 can act as an inclined surface on which washing agent 2 slides towards discharge aperture 4A facing discharge 4B and obtained in casing 3 of dispenser 1; as can be seen in FIGS. 1 and 2, in fact, the longitudinal axis of chamber 5 is inclined relative to a horizontal direction, i.e. a direction perpendicular to direction V.

More specifically, FIGS. 1 and 2 show that piston 59 and consequently also chamber 5 translate linearly to and from discharge 4B (or inlet 7B), said translational movement being attained by means of at least one actuator.

The latter is preferably a thermoactuator 9, i.e. a thermal or thermoelectric actuator, and comprises an outer casing 91, typically made of electrically insulating material such as plastic, which casing 91 houses at least one actuating element, e.g. comprising a body made of electrically and thermally conductive material (e.g. metal) which contains an expandable material, possibly connected to or associated with an electric heater; within said body of the actuating element a volume is defined for housing said expandable and/or thermally dilatable material (e.g. wax) operationally associated with a thrust element adapted to move linearly a drive shaft 92 protruding from the outer casing; the electric heater typically consists of a positive temperature coefficient (PTC) resistor receiving electric power through two terminals shown in the drawing.

Said thermal actuator may nevertheless also be of a different type, e.g. comprising bimetallic or shape memory alloy elements; it may be an electromagnetic actuator and/or comprise an electric motor or even a set of kinematic units (e.g. toothed wheels and/or drive shafts or the like) controlled by a suitable actuator and adapted to move drive shaft 92 and/or piston 59 in a predefined direction, preferably with a linear or slightly arched translation.

In the example provided herein, drive shaft 92 acts upon piston 59, in particular at rear head wall 53 of chamber 5, which in turn is connected to front head wall 54 on the opposite side of chamber 5 (e.g. through connecting portions or walls or rods, not shown in this drawing), said head walls moving jointly and creating a real piston 59 sliding within seat 50 defined in casing 3 of dispenser 1.

Head walls 53 and 54 therefore translate to and from discharge 4B (or to and from inlet 7B) by following the movement of drive shaft 92, thus moving or positioning chamber 5 in the two positions of FIG. 1 and FIG. 2.

In this regard, it should be noted that in this embodiment the axis of actuator 9 and/or of drive shaft 92 is also inclined relative to washing agent drop direction V; in particular, it translates linearly parallel to direction O, so as to move chamber 5 at an angle; it should however be taken into account that said movement of chamber 5 may also be obtained with an actuator 91 arranged in a different position or at a different angle, possibly through additional kinematic systems arranged in between.

The first embodiment described so far has further advantageous features: for example, as can be seen in the drawings, discharge 4B and inlet 7B have shapes and dimensions such that discharge aperture 4A and supply aperture 7A take up only a portion of the peripheral or perimetric walls delimiting chamber 5; these features of inlet 7B and discharge 4B (or of supply aperture 7A and discharge aperture 4A) may also be provided independently of each other.

In the discharge condition of FIG. 2, front head wall 54 (while moving within seat 50) goes beyond discharge 4B, whereas rear head wall 53 stays in a remote position with respect to discharge 4B (in the illustrated example it closes inlet 7B), so that in this condition chamber 5 still retains at least a portion of bottom wall 51, which is the sliding surface on which washing agent 2A slides or flows as it is being discharged; on the contrary, in the supply condition of FIG. 1 rear head wall 53 goes beyond inlet 7B while moving within seat 50, whereas front head wall 54 stays in a remote position with respect to supply mouth 7B (in the illustrated example it closes discharge 4B), so that in this condition chamber 5 still retains a portion of top wall 51, which is the sliding surface against which the air rises up from chamber 5 to reservoir 6 and/or which promotes a proper accumulation of washing agent 2.

The shape and position of inlet 7B and discharge 4B are preferably such that no detergent stagnation can occur during the discharge step and/or in the discharge area and/or no air stagnation can occur during the supply step and/or in the supply area.

It follows that, while according to the prior art washing agent 2, 2A was supplied or discharged through a supply or discharge aperture which took up fully one or more perimetric walls (thus causing the chamber, for example, to lose the whole top surface during the supply step or the whole bottom surface during the discharge step), according to the present invention the perimetric walls that define chamber 5 are only partially affected by supply aperture 7A and discharge aperture 4A, so that in the example illustrated herein chamber 5 always retains at least a portion of bottom surface 51 during the discharge step and a portion of top surface 52 during the supply step in order to provide the advantageous effects previously described.

In practice, inlet 7B and discharge 4B are provided in the form of ports opening on only a limited portion of top surface 52 and bottom surface 51, since their shape and dimensions are smaller than those of the longitudinal section of chamber 5 and/or of said surfaces 51 and 52.

This ensures the above-mentioned advantage of a more compact dispenser: in fact, the volume being equal, movable chamber 5 makes a smaller movement between the first and second positions, which is also beneficial in terms of compactness and strength of actuator 9, which can thus be equipped with a shorter drive shaft 92 and consequently also with a shorter casing 91.

It should also be noted that in a possible variant (not shown) of the example described with reference to FIGS. 1 and 2 it is also possible to provide that at least a portion of bottom wall 51 and/or top wall 52 is integral with rear head wall 53 and/or front head wall 54, without however departing from the teachings and objects of the present invention.

Finally, it should be pointed out that the combination of all or at least some of the features described so far implies a number of synergic advantages which allow to obtain a chamber in which the washing agent is supplied, discharged and metered in an accurate and optimal manner while attaining considerable cost savings in terms of functional parts.

The description will now tackle the second embodiment shown in FIGS. 3 and 4, wherein the same parts, which will not be described any further for simplicity, are designated by the same reference numerals followed by an apostrophe '.

This solution also implements the basic principle of the present invention; in fact, it can be seen that bottom surface 51′ and top surface 52′ of movable chamber 5′ are inclined relative to the washing agent drop direction, thereby obtaining the same advantages already described.

A first difference between the first and second variants of the non-limiting examples shown in FIGS. 1 to 4 is that in this latter case at least a portion of said bottom surface 51′ and top surface 52′ is integral with movable head walls 53′ and 54′ of chamber 5′, and therefore also with metering piston 59′, and translates therewith to and from discharge 4B′ and/or inlet 7B′.

One substantial difference between the first and second variants is that, while in the solution of FIGS. 1 and 2 movable chamber 5 translates between the first and second positions and vice versa along an inclined path, in the variant of FIGS. 3 and 4 chamber 5′ follows a horizontal path or a path which is substantially perpendicular to washing agent drop direction V, and movable chamber 5′ has a longitudinal axis which is inclined in direction O, which direction O is therefore also inclined relative to the direction of translation.

Although reference has been made so far to substantially linear translational movements, it is worth mentioning in this respect that such translations may likewise be angular or of a different type, such as a movement following a slightly arched path (or trajectory).

To this end, chamber 5′ is defined between perimetric walls comprising bottom surface 51′ and top surface 52′, which surfaces 51′ and 52′ are inclined relative to the direction of translation and/or to the axis of drive piston 92′; those portions of bottom surface 51′ and top surface 52′ which are not in one piece with casing 3 are obtained in one piece with metering piston 59′ and, unlike the previous version, move together with metering piston 59′; a more detailed description of an example of the latter will be provided below with reference to additional drawings.

In this regard, it should be pointed out that in this embodiment the axis of drive shaft 92′ is perpendicular to washing agent drop direction V, i.e. it is substantially horizontal, so that chamber 5′ is moved horizontally to and from inlet 7B′ discharge 4B′, also in this case provided in the form of ports, so that inlet aperture 7A′ and discharge aperture 4A′ affect the perimetric walls of chamber 5′ only partially.

It is also worth mentioning that this solution too may be implemented with only either bottom surface 51′ or top surface 52′ inclined, although the best advantages are attained when both surfaces are inclined.

As discussed with reference to the first solution, it is conceivable that only either inlet 7B′ or discharge 4B′ is smaller than the horizontal section of chamber 5′ and/or the extension of bottom surface 51′ or top surface 52′, and/or has such dimensions as to generate an inlet aperture 7A′ and/or a discharge aperture 4A′ that partly affects one or more perimetric walls of the chamber, even though also in this case the best advantages are attained when both have this feature, as shown in FIGS. 3 and 4.

Just like the previous solution, these combined features of the second embodiment lead for the same reason to the above-mentioned advantages in terms of supply, discharge, metering and general production costs.

It is also worth pointing out that in both versions dispenser 1, 1′ is perfectly operational with both powder and liquid washing agents 2, 2′, whereas prior-art solutions are generally dedicated to one type of washing agent only (either powder or liquid) and suffer from some problems when the reservoir is filled with a different type of washing agent, due to the different nature (powder or liquid) thereof It is appropriate to underline that when liquid washing agents 2, 2′ are used, the air expelled from chamber 5, 5′ to reservoir 6, 6′ contributes to ensuring a proper filling of chamber 5, 5′ itself, thus leading to accurate metering.

If washing agent 2, 2′ is a powder, it will tend to fill chamber 5, 5′ by accumulating according to the natural slope angle of said powder; in this case, in addition to expelling the air, inclined top wall 52, 52′ may have a predefined angle which ensures a proper filling of the chamber.

In order to attain said advantages, the angle defined between inclined top wall 52, 52′ and direction V, identified in the same sectional plane, is preferably in the range of 1° to 80°; more specifically said angle is in the range of 5° to 35°.

Moreover, it can be seen in both examples illustrated above that the movement required for the execution of supply, metering and discharge operations is extremely small, resulting in a more compact dispenser: the volume of the washing agent contained therein being equal, dispenser 1, 1′ thus made can be provided with an actuator 9, 9′ having a shorter stroke, or, the stroke being equal, it can be provided with a bigger chamber 5,5′.

In both examples described herein, the means adapted to facilitate the supply and/or discharge of the washing agents are obtained from a sliding surface generated by an inclined shape of at least a portion of top surface 52, 52′ and bottom surface 51, 51′ of chamber 5, 5′ with respect to the vertical or to the washing agent drop direction V when the dispenser is in the operating condition or properly installed; more in detail, in both solutions top surface 52, 52′ and/or bottom surface 51, 51′ extend obliquely downwards in the direction from inlet 7B, 7B′ to discharge 4B, 4B′.

Before proceeding any further in the description, it should still be pointed out that both versions referred to herein are not to be intended as limiting examples; in fact, after having understood the basic principles of the invention described above, those skilled in the art will be able to implement them effortlessly also in solutions differing from those described in detail below.

In the following non-limiting examples, inlet 7B is an inlet mouth and discharge 4B is a discharge mouth.

Within a more detailed description of a practical implementation in accordance with the teachings of FIGS. 1 and 2, reference will be made to FIGS. 5 to 11, wherein the same reference numerals followed by ″ designate the same parts of FIGS. 1 and 2.

In the illustrated example, supply mouth 7B″ is provided in the form of a port obtained in the wall of shell 55″ which in this embodiment is the guide within which metering piston 59″ slides; in this example, the inlet aperture is supply port 7A″, which extends at least partly radially and opens when, during the supply step, the rear wall of metering piston 59″ goes beyond supply mouth 7B″, thus placing it in communication with chamber 5″.

The discharge aperture is provided in the form of a discharge port 4A″, which in the illustrated example extends at least partly radially around the discharge mouth 4B″, located at an open free end of shell 55″.

Referring specifically to FIG. 8, in this non-limiting example chamber 5″ has a circular cross-section and is delimited, in this embodiment, by open-ended cylindrical tubular shell 55″ and by head walls 53″ and 54″, which are comprised in metering piston 59″ together with crosspieces 56″.

At the end opposite to discharge mouth 4B′, the shell has a protruding edge 61″; within its extension, shell 55″ also has an upper supply mouth 7B″ facing reservoir 6″; in the illustrated example (see FIGS. 7 and 8), there is also a second auxiliary supply mouth 7C″, which can be used to advantage during the supply step, as will be described below.

Metering piston 59″ is driven by drive shaft 92″, in turn actuated by thermoactuator 9″, and the same metering piston 59″ is acted upon by an elastic countering element, e.g. a spring 99″, applied between the dispenser casing and metering piston 59″; as an alternative to or in combination with said element, actuator 9″ may advantageously be equipped with an inner resilient element or spring of its own, adapted to at least reset the position of drive shaft 92″.

In the supply position shown in FIG. 5, drive shaft 92″ is retracted and head wall 53″ exposes supply mouth 7B″, thereby opening supply port 7A″ through which the washing agent enters chamber 5″, which is then filled completely; in this regard, reference should be made to FIG. 7, which clearly shows how top surface 52″ of chamber 5″, inclined upwards in the direction of supply port 7A″, expels all the air contained in chamber 5″ by rising naturally towards reservoir 6″, thus allowing chamber 5″ to be filled thoroughly and ensuring a correct metering of the washing agent: in fact, if top surface 52″ of chamber 5″ were not inclined as shown, it would be necessary to provide an air vent; otherwise, the air would stay trapped within chamber 5″ and cause a partial filling thereof, leading to an incorrect metering of washing agent 2″.

Referring now to FIG. 7, there is shown an initial moment of the supply step, at which the metering piston has just moved or is still moving towards actuator 9″: in this condition, the air is expelled (as described above) mainly through supply port 7A″, which also allows the washing agent to come in from reservoir 6; as can be seen, in this condition also auxiliary mouth 7C″ is open, thus being in fluidic communication with chamber 5″ and allowing washing agent to come in from below as well: during these first instants, in fact, the quantity of air contained in chamber 5″ is quite large (the chamber is substantially full of air), and in the event that (especially when a liquid washing agent is used) the air rising through upper supply mouth 7B″ should partially hinder the entry of the washing agent from the same mouth 7B″, then the simultaneous opening of auxiliary supply mouth 7C″ (which during these first instants is also in fluidic communication with reservoir 6″) will assist in filling chamber 5″; furthermore, said auxiliary supply mouth 7C″ will also promote the flow of any washing agent trapped in the area between piston 59″ and actuator 9″. The presence of two supply mouths 7B″ and 7C″ opposite to each other also provides part symmetry, thus making some installation steps easier.

In the position shown in FIG. 6, on the contrary, drive shaft 92″ is extracted and has moved metering piston 59″ (and consequently chamber 5″) towards discharge mouth 4B″: in this position, head wall 54″ has gone past the edge of shell 55″, thus exposing discharge mouth 4B″ and opening discharge port 4A″ (and therefore opening chamber 5″ towards the tub), thereby allowing washing agent 2A″ contained in chamber 5″ to be discharged by sliding freely downwards, assisted by the inclined plane consisting of inclined bottom surface 51″ of chamber 5″.

As can be seen, in this embodiment shell 55″ is a tube having a circular cross-section, though it may in general have any other shape as well.

In this solution, bottom surface 51″ and top surface 52″ of the chamber consist of the lower and upper portions of shell 55″, which extends longitudinally along a plane inclined in direction O relative to the washing agent drop direction V and parallel to that of drive shaft 92″ of thermoactuator 9″, i.e. parallel to the direction of movement of metering piston 59″ within cylindrical shell 55″, as clearly shown in the enlarged views of FIGS. 5 and 6.

It is also worth mentioning that also in this example supply port 7A″ and discharge port 4A″ each affect only partially at least one of the peripheral walls delimiting chamber 5″, leading to the advantages described above.

It should be noted that, although shell 55″ has been described so far as an individual part separated from the dispenser casing, it may alternatively be incorporated into or obtained in one piece with the latter; of course, the provision of the shell as an individual part implies some advantages in terms of materials (which can be different for the dispenser and the shell), dimensional tolerances (which must be closer for the shell) and installation (which is facilitated).

At the end of the discharge step, the thermoactuator is turned off and drive shaft 92″ is free to return into its seat, pushed by spring 99″ through metering piston 59″, so as to be ready for a new cycle; as aforementioned, actuator 9″ may also be provided with an inner resilient element or spring of its own.

FIGS. 10 and 11 show dispenser 1″, which preferably consists of at least two half-casings or half-shells 1A″ and 1B″ made of plastic material and associated with or welded to each other to form dispenser 1″, which is normally partly embedded into a vertical wall of the washing machine.

FIG. 9 shows the half-shell 1B″, which is typically adapted to provide the dispenser portion partly embedded in the user apparatus or dishwasher, and which provides a portion of reservoir 6″; the same drawing also shows the already described supply mouth 7B″ and spring 99″.

According to a variant which is advantageous in terms of assembly and installation simplicity, shell 55″ and spring 99″ preferably consist of independent parts mounted directly into half-shell 1B″.

Referring now to FIGS. 12 to 17, there is shown a dispenser 1* in accordance with the teachings discussed above with reference to FIGS. 3 and 4.

Corresponding reference numerals followed by an asterisk * designate the same parts referred to so far, which will not be described any further.

As can be seen in FIGS. 13, 14 and 15, in this embodiment chamber 5* is delimited by an inclined bottom surface 51*, an inclined top surface 52*, and two head walls 53* and 54* partly comprised in metering piston 59* that slides within the cylinder provided in the form of a tubular shell 55* which constitutes seat 50*.

In this example, head walls 53* and 54* are joined by a central wall 500* extending longitudinally and preferably dividing chamber 5* into at least two smaller chambers.

As will become apparent later on, said central wall 500* may be omitted and/or replaced with suitable crosspieces for the purpose of making head walls 53* and 54* integral with each other.

Metering piston 59* is made to slide (just like metering piston 59″) by thermoactuator 9* through drive shaft 92* and countering spring 99*.

FIG. 12 (and the enlarged view thereof) shows chamber 5* during the supply step: head wall 53*, pushed by spring 99* acting upon metering piston 59*, keeps open supply port 7A* through which chamber 5* is in fluidic communication with reservoir 6*, so that washing agent 2* contained in the latter is supplied by gravity into the chamber; preferably, said open condition of supply port 7A* is obtained with actuator 9* idle or de-excited.

Again, it should be noted that, just as described above with reference to chamber 5′, inclined top surface 52* advantageously ensures the elimination of any air bubbles towards the reservoir and/or a proper filling of the chamber with a powder washing agent, resulting in an accurate metering thereof.

As shown in the intermediate position of FIG. 14, the washing agent is supplied in a simple manner and in the proper dose; as clearly shown in this drawing, in this example as well supply port 7A* affects only partially the peripheral walls that delimit chamber 5*, in particular top surface 52*.

The supply step is shown in FIG. 13 and in the enlarged view thereof, where it is possible to see that head wall 54* has gone past the edge of shell 55*, thereby opening discharge port 4A* and placing chamber 5* in fluidic communication with the tub. In this case as well, discharge port 4A* (and/or discharge mouth 4B) has smaller dimensions and shape than chamber 5* and only partially affects the peripheral walls delimiting chamber 5*.

Discharge is promoted by inclined bottom surface 51* as previously described, thus preventing any washing agent from accumulating inside chamber 5*.

It should be pointed out that in this case both top surface 52* and bottom surface 51* of chamber 5* are at least partly made up of movable portions integral with metering piston 59* and preferably also with head walls 53* and 54*.

In this case as well, as shown in FIGS. 16 and 17, dispenser 1* is preferably made up of at least two plastic half-shells 1A* and 1B*, and is applied, just like dispenser 1″, to a vertical wall of the washing machine; likewise, reservoir 6* is partly obtained in rear half-shell 1B* as shown in FIG. 16, which shows both supply mouth 7B* and spring 99*.

FIGS. 18 to 23 illustrate a possible variant implementation of a metering piston 59̂ which is alternative to metering piston 59*; in these drawings, the same parts are designated by the same reference numerals followed by A: in particular, in FIG. 23 metering piston 59̂ is slideably housed in shell 55̂ so as to partly define the chamber delimited by at least head walls 53̂ and 54̂ and by the inclined top surface portion 52̂ and the inclined bottom surface portion 51″ integral with metering piston 59̂.

A comparison between metering piston 59* and metering piston 59̂ reveals that central wall 500* of the former has been replaced in this case with two crosspieces, both designated by reference numeral 500̂, which allow the two head walls 53̂ and 54̂ to be made integral with each other without having to subdivide chamber 5̂, which in this case is therefore a single chamber.

The shape of metering piston 59̂ is shown in more detail and from different viewpoints in FIGS. 18 to 22, which show how inclined bottom surface portion 51̂ and inclined top surface portion 52̂ are substantially parallel to each other and connect together the opposite head walls 53̂ and 54̂, which are also substantially parallel to each other. In order to preserve the chamber angle obtained with shell 55̂, bottom surface 51̂ and top surface 52̂ are askew or oblique relative to head walls 53̂ and 54̂ so that, just like chamber 5′ obtained by using metering piston 59′, also in this case the extension of the chamber is inclined with respect to its axis of translation.

In this case, too, bottom surface 51̂ and top surface 52̂ are partly integral with head walls 53̂ and 54̂ and with metering piston 59̂, and translate therewith to and from discharge mouth 4B̂.

FIGS. 24 and 25 show a metering piston 59′″ and the corresponding shell 55′″ which are alternative to piston 59″ and shell 55″; the parts performing the same functions are designated by the same reference numerals followed by ′″ and will not be described any further.

It is worth dwelling upon the fact that in this case head walls 53′″ and 54′″ are made integral with each other by means of a cross-like crosspiece 500′″ whose arms preferably intersect at the centre of chamber 5′″ and extend radially from the point of intersection for a distance which is shorter than the distance between the point of intersection and the walls of shell 55′″ when metering piston 59′″ is mounted; four half-chambers are thus obtained, which are in peripheral communication with one another.

Interestingly, it can be noted that metering piston 59′″ according to this variant has two sealing elements or gaskets 80′″ and 81′″ arranged radially around the outer edge of front wall 54′″ and rear wall 53′″, respectively, so as to create a seal between these walls and the inner walls of the shell 55′″, which is particularly useful when using liquid washing agents: in fact, the gaskets provide a seal inside shell 55′″ in which piston 59′″ slides.

During the supply step, gasket 81′″ exposes supply mouth 7B′″ at least partially, thereby placing movable chamber 5′″ in fluidic communication with reservoir 6′″, while gasket 81′″ provides a seal against the inner walls of shell 55′″ and prevents any undesired leakage of washing agent into the tub.

On the contrary, during the discharge step gasket 80′″ is sealingly engaged with the shell, and the discharge port opens because gasket 81′″ moves past the edge of shell 55′″, where there is the discharge mouth 4B′″, so as to allow the washing agent to be discharged while at the same time preventing any undesired leakage from the reservoir.

Advantageously, gaskets 80′″ and 81′″ consist of two sealing lips extending circumferentially around front wall 54′″ and rear wall 53′″: for this purpose, rear wall 53′″ is thinner at its peripheral edge 89′″, from which the sealing lip forming gasket 80′″ extends (when not engaged with shell 55′″) beyond the diameter of corresponding head wall 53′″, so that, when deformed by being inserted in the shell, it exerts an elastic reaction force capable of ensuring a perfect seal; for this purpose, the sealing lip is slightly inclined relative to head wall 53′″ and becomes thinner towards its end corresponding to the free edge, so as to get deformed mainly at said end and bend evenly against the wall of shell 55′″, thereby generating a sealing edge preferably extending axially and radially against it.

Likewise, gasket 81′″ consists of a sealing lip extending circumferentially around wall 54′″ and (when not sealingly engaged with shell 55′″) beyond the diameter of the latter, so that, when deformed by being inserted in shell 55′″, it exerts an elastic reaction force capable of ensuring a perfect seal; similarly, it should be pointed out that also in this case the sealing lip forming gasket 81′″ is not perpendicular to head wall 54′″, but slightly inclined outwards and becomes thinner at its end corresponding to the free edge, so as to get deformed mainly at said end and bend evenly against the wall of shell 55′″, thereby generating a sealing edge extending axially and radially against it.

It should be observed that, in order to facilitate the insertion of said lips 80′″, 81′″ into shell 55′″, respective bevels 82′″ and 83′″ are preferably provided: bevels 82′″ are at least present on the portion of the inner surface of shell 55′″ facing supply mouths 7B′″ and 7C′″ on the side of movable chamber 5′″, whereas bevel 83′″is arranged radially around discharge mouth 4B′″.

According to an additional advantageous feature, sealing lips 80′″ and 81′″ are made in one piece with metering piston 59′″ or at least with some parts thereof, such as respective head walls 53′″ and 54′″: in fact, sealing lips 80′″ and 81′″ may be manufactured during the same production step, e.g. a moulding step, of metering piston 59′″, and are preferably made of the same material used for at least one rigid part of metering piston 59′″.

A thermoplastic material such as polypropylene (PP) or polyethylene (PE) may advantageously be used, which materials are substantially rigid when relatively thick, and substantially elastic when relatively thin, thus ensuring that sealing lips 80′″, 81′″ are sufficiently elastic to provide a proper seal against the inner walls of shell

Said plastic materials such as polypropylene (PP) or polyethylene (PE) are advantageously cheap, but they notoriously suffer from problems of dimensional tolerances during the shrinking step that follows the moulding step.

These problems, which may in principle cause washing agent to leak between head walls 53′″ and 54′″ and shell 55′″, are solved in a very economical manner by the present solution, since the dimensional tolerance gap is compensated for by sealing lips 80′″ and 81′″ themselves.

In the absence of said sealing lips 80′″ and 81′″, it is conceivable to employ another thermoplastic material having better dimensional stability but being typically more expensive.

Referring back to metering piston 59′″ of FIGS. 24 and 25, it is preferably made up of two separate parts assembled together: in particular, each of the two parts includes at least one of two sealing lips 80′″, 81′″; in fact, in the illustrated example two undercuts 87′″ and 88′″ (between lip 80′″, 81′″ and the corresponding head wall 53′″ and 54′″) have specular cavities oriented in opposite directions.

In general, in the practical examples illustrated above chamber 5″,5*,5̂,5′″ is defined at least partly by a shell 55″, 55*, 55̂,55′″ extending along an inclined or horizontal directrix (according to the case) with respect to washing agent drop direction V (which is substantially vertical and pointed downwards, in accordance with the force of gravity), when the dispenser is properly installed, and by head walls 53″, 54″, 53*, 54*, 53̂, 54̂, 53′″, 54′″, preferably having a disc-like shape so as to form the bases of cylindrical shell 55″, 55*, 55̂,55′″.

It should be noted that front head wall 54″, 54*, 54̂, 54′″ has a step-like projection 540″, 540*, 540̂, 540′″ at which its dimensions increase from an initial segment facing chamber 5″,5*, 5̂, 5′″, where the diameter of front head wall 54″, 54*, 54̂, 54″' is smaller than the inner diameter of cylindrical shell 55″, 55*, 55̂,55′″, to a rear segment facing the countering spring, where its diameter is greater than the inner diameter of shell 55′, 55*, 55̂,55′″: this step-like projection 540″, 540*, 540̂, 540′″ allows head wall 54, 54′, 54″, 54′″ to act like a plug against discharge mouth 4B″, 4B *, 4B̂, 4B′″ of shell 55″, 55*, 55̂, 55′″.

In other words, front head wall 54″, 54*, 54̂, 54′″ also has a housing and/or positioning seat 100″, 100*, 100̂, 100′″ for spring 99″, 99*, 99̂, preferably shaped like a cup, and on the edge of the seat or cup step-like projection 540″, 540*, 540̂, 540′″ is arranged, which is obtained as a radial extension of annular wall 183″, 183*, 183̂, 183′″ that at least partly defines the perimeter of said spring seat 100″, 100*, 100̂, 100′″.

At said step-like projection 540″, 540*, 540̂, 540′″, a gasket 74″, 74*, 74̂, 74′″ may advantageously be arranged which may be associated with the edge of head wall 540″, 540*, 540̂, 540′″ in order to create a watertight seal against the mouth of shell 55″, 55*, 55̂, 55′″, said gasket 74″, 74*, 74̂, 74′″ being subject to compression and being thus protected against wear; in fact, it is simply compressed between said step-like projection 540″, 540*, 540̂, 540′″ and the edge of shell 55″, 55*, 55̂,55′″, so as to create a watertight seal by compression while preventing wear and reducing the mechanical resistance exerted against the actuator when compressed.

It is appropriate to point out that gasket 74″,74*,74̂,74′″ is placed in the sealing condition in an idle or inoperative condition of the actuator, corresponding to the spring being extended; such condition advantageously allows to keep chamber 5″,5*,5̂,5′″ closed towards the tub when the washing machine using this dispenser is not in operation, thus ensuring a proper seal whenever the dispenser is not in use, which time is typically longer than the machine's operating time.

According to an advantageous feature, gasket 74″,74*,74̂,74′″ may either be manufactured in one piece with metering piston 59″,59*,59̂,59′″ or be associated/associable therewith during a step prior to assembly, so as to simplify the assembly process.

The various gaskets or sealing elements 74″,74*,74̂,74′″, 80′″, 81′″ may advantageously be manufactured by moulding a preferably elastic material directly onto metering piston 59,59′,59″,59*,59̂,59′″.

Another advantageous feature is also worth mentioning, which derives from the fact that in the illustrated embodiments supply mouth 7B″, 7B*, 7B̂, 7B′″ opens only after discharge mouth 4B″, 4B*, 4B̂, 4B′″ has been closed, so that there is never a direct connection between the reservoir and the tub, which is beneficial for a correct feeding of the washing agents: to this end, the smaller-diameter section of step-like projection 540″, 540*, 540̂, 540′″ is inserted into shell 55″, 55*, 55̂, 55′″ and closes discharge mouth 4B″, 4B*, 4B̂, 4B′″ before supply mouth 7B″, 7B*, 7B̂, 7B′″ is placed in fluidic communication with the movable chamber.

Preferably, discharge mouth 4B″, 4B*, 4B̂, 4B′″ is closed at least partly by the smaller-diameter portion of step-like projection 540″, 540*, 540̂, 540′″ before gasket 74″, 74*, 74̂, 74′″ is compressed, thus ensuring the advantages described above.

Of course, the man skilled in the art may conceive several variants, all of which will still fall within the scope of the present invention; for example, he may create a chamber having any polygonal section (e.g. rectangular or square) and correspondingly employ different shell sections.

As can be seen, in all of the examples discussed herein movable chamber 5, 5′, 5″, 5*, 5̂, 5′″ can only open either towards reservoir 6, 6′, 6″, 6* or towards the tub, and preferably has no additional apertures (apart from the supply and discharge ones) which may cause the washing agent to be metered incorrectly and make the manufacturing process more complex.

As another possible variant, it can be observed that substantially the same advantages discussed so far can be attained even if only a segment or portion of bottom surface 51, 51′, 51″, 51*, 51̂, 51′″ or top surface 52, 52′, 52″, 52*, 52̂, 52″' of chamber 5, 5′, 5″, 5*, 5̂, 5′″ is at least partly inclined in an operating condition of the dispenser as previously defined, and more in particular when bottom surface 51, 51′, 51″, 51*, 51 ̂, 51′″ converges towards discharge mouth 4B, 4B′, 4B″, 4B*, 4B̂, 4B′″ and top surface 52, 52′, 52″, 52*, 52̂, 52′″ converges towards supply mouth 7B, 7B′, 7B″, 7B*, 7B̂, 7B′″.

Of course, the man skilled in the art may also conceive the presence of additional sealing gaskets, such as O-rings or the like, between any relatively moving or mating surfaces in order to prevent any accidental leakage of washing agent, without however departing from the scope and teachings of the present invention.

A further variant may employ two dispensers connected together, at least one of which being made in accordance with the teachings of the present invention, thus creating a combined dispenser: in this latter case, it is conceivable to use a single casing 3 accommodating both dispensers.

Furthermore, although head walls 53, 54, 53′, 54′, 53″, 54″, 53*, 54*, 53̂, 54̂, 53′″, 54′″ have been described herein as being substantially flat, they may alternatively be curved, concave, convex or have any other suitable shape.

Likewise, it is conceivable to employ a bottom surface 51, 51′, 51″, 51*, 51̂, 51′″ which slopes down in a curvilinear manner towards discharge mouth 4B, 4B′, 4B″, 4B*, 4B̂, 4B′″ or a top surface 52, 52′, 52″, 52*, 52̂, 52′″ rising upwards in a curvilinear manner at least towards supply mouth 7B, 7B′, 7B″, 7B*, 7B̂, 7B′″, or a bottom surface 51, 51′, 51″, 51*, 51̂, 51′″ or a top surface 52, 52′, 52″, 52*, 52̂, 52′″ which are only partially inclined or curved.

More in general, it must be pointed out that supply mouth 7B, 7B′, 7B″, 7B*, 7̂, 7B′″ and/or discharge mouth 4B, 4B′, 4B″, 4B*, 4B̂, 4B′″ may have any shape suitable for the respective purposes, e.g. elongated ducts with slots, doors, radial or arched apertures, or the like.

Of course, it is also conceivable to generate an overpressure within said movable chamber in order to further improve the discharge of the washing agent; however, the dispenser according to the present invention can provide optimal discharge without needing any pump assistance, thus offering substantial savings in terms of functional parts.

1-17. (canceled)

18. Dispenser (1, 1′, 1″, 1*) for washing agents (2, 2′, 2″, 2*), in particular of the type adapted to dispense a washing agent (2, 2′, 2″, 2*) into a tub of a washing machine, comprising at least one casing (3, 3′, 3″, 3*) that comprises at least one reservoir (6, 6′, 6″, 6*) for washing agents, and a metering element provided with at least one movable chamber which can translate linearly between a first and a second position respectively corresponding to a supply condition, wherein washing agents (2, 2′, 2″, 2*) are supplied from the reservoir (6, 6′, 6″, 6*) into the movable chamber, and a discharge condition wherein the washing agents (2, 2′, 2″, 2*) are discharged from the movable chamber into the tub,
characterized in that
the movable chamber comprises means (59, 59′, 59″, 59*, 59′″, 5, 5′, 5″, 5*, 5′″, 55, 55′, 55″, 55*, 55′″) provided with at least one sliding surface (51, 51′, 51″, 51*, 51′″, 52, 52′, 52″, 52*, 52∝″), adapted to facilitate said supply and/or discharge of the washing agents (2, 2′, 2″, 2′″) and inclined with respect to a direction of drop by gravity of the washing agents″.

19. Dispenser (1, 1′, 1″, 1*) according to claim 18, wherein said means (59, 59′, 59″, 59*, 59̂, 59′″, 5, 5′, 5″, 5*, 5̂, 5′″, 55, 55′, 55″, 55*, 55̂, 55′″) and/or said sliding surface (51, 51′, 51″, 51*, 51̂, 51′″, 52, 52′, 52″, 52*, 52̂, 52′″) comprise at least a portion of a top surface (52, 52′, 52″, 52*, 52̂, 52′″) that at least partly defines or delimits said movable chamber (5, 5′, 5″, 5*, 5̂, 5′″), said top surface (52, 52′, 52″, 52*, 52̂, 52′″) being at least partly inclined.

20. Dispenser (1, 1′, 1″, 1*) according to claim 19, wherein said top surface (52, 52′, 52″, 52*, 52̂, 52′″) is inclined relative to the vertical or to the direction (V) in which the washing agent drops from the reservoir (6, 6′, 6″, 6*) into the movable chamber (5, 5′, 5″, 5*, 5̂, 5′″), in particular to facilitate the expel of air from the movable chamber (5, 5′, 5″, 5*, 5′″) into the reservoir (6, 6′, 6″, 6*).

21. Dispenser (1, 1′, 1″, 1*) according to claim 18, wherein the movable chamber (5, 5′, 5″, 5*, 5̂, 5′″) is defined or delimited by at least one bottom surface (51, 51′, 51″, 51*, 51̂, 51′″), and the means adapted to facilitate the discharge of the washing agent comprise a segment or portion of the bottom surface (51, 51′, 51″, 51*, 51̂, 51′″) which is at least partly inclined relative to the direction (V) in which the washing agent drops from the movable chamber (5, 5′, 5″, 5*, 5̂, 5′″) into the tub in an operating condition of the dispenser (1, 1′, 1″, 1*), thus promoting the sliding of the washing agents (2, 2′, 2″, 2*) by gravity towards said drain (4B, 4B′, 4B″, 4B*, 4B̂, 4B′″).

22. Dispenser (1, 1′, 1″, 1*) according to claim 18, wherein said drain is a drain mouth (4B, 4B′, 4B″, 4B*, 4B̂, 4B′″) which can be opened during the discharge condition in order to create a drain aperture (4A, 4A′, 4A″, 4A*) partially obtained in one or more peripheral walls (51, 51′, 51″, 51*, 51̂, 51′″, 52, 52′, 52″, 52*, 52̂, 52′″, 50, 50′, 55″, 55*, 55̂, 55′″, 53, 54, 53′, 54′, 53″, 54″, 53*, 54*, 53̂, 54̂, 53′″, 54′″).

23. Dispenser (1, 1′, 1″, 1*) according to claim 18, wherein said inlet is a supply mouth (7B, 7B′, 7B″, 7B*, 7B̂, 7B′″) which can be opened during the supply condition in order to create a supply aperture (7A, 7A′, 7A″, 7A*) partly obtained in one or more peripheral walls (51, 51′, 51″, 51*, 51̂, 51′″, 52, 52′, 52″, 52*, 52̂, 52′″, 50, 50′, 55″, 55*, 55̂, 55′″, 53, 54, 53′, 54′, 53″, 54″, 53*, 54*, 53̂, 54̂, 53′″, 54′″).

24. Dispenser (1, 1′, 1″, 1*) according to claim 18, wherein, in the operating condition of the dispenser (1, 1′, 1″, 1*), the movable chamber (5, 5′, 5″, 5*, 5̂,5′″) extends obliquely or is inclined downwards relative to the washing agent drop direction (V) in the direction from the inlet (7B, 7B′, 7B″, 7B*, 7B̂, 7B′″) to the drain (4B, 4B′, 4B″, 4B*, 4B̂, 4B′″).

25. Dispenser (1, 1′, 1″, 1*) according to claim 18, wherein the peripheral walls that define or delimit the movable chamber (5, 5′, 5″, 5*, 5̂,5′″) comprise at least two opposite movable head walls (53, 54, 53′, 54′, 53″, 54″, 53*, 54*, 53̂, 54̂, 53′″, 54′″) integral with each other and comprised within a metering piston (59,59′,59″,59*,59̂,59′″), which is preferably slideably driven by an actuator, such as a thermoactuator (9,9′,9″,9*,9̂).

26. Dispenser (1, 1′, 1″, 1*) according to claim 18, wherein the peripheral walls that define or delimit the movable chamber (5, 5′, 5″, 5*, 5̂,5′″) comprise at least a portion of a shell (50, 50′, 55″, 55*, 55̂, 55′″), preferably tubular in shape, and wherein the head walls (53, 54, 53′, 54′, 53″, 54″, 53*, 54*, 53̂, 54̂, 53′″, 54′″) and/or the metering piston (59,59′,59″,59*,59̂,59′″) can slide inside the shell (55″, 55*, 55̂, 55′″) .

27. Dispenser (1, 1′, 1″, 1*) according to claim 18, wherein said supply mouth (7B″, 7B*, 7BA, 7B′″) is obtained radially in said shell (55″, 55*, 55̂, 55′″), in which said movable chamber (5) moves, and said drain mouth (4B, 4B′, 4B″, 4B*, 4B̂, 4B′″) is coincident with an open end of said shell (55″, 55*, 55̂, 55′″), said supply aperture (7A, 7A′, 7A″, 7A*) and/or said drain aperture (4A, 4A′, 4A″, 4A*) being provided in the form of supply and/or drain ports which are opened or closed by the movement of said metering piston (59,59′,59″,59*,59̂,59′″).

28. Dispenser (1, 1″) according to claim 18, wherein, when the dispenser (1, 1″) is in the operating condition, the movable chamber (5, 5″, 5′″) translates in a direction (O) which is inclined relative to the washing agent drop direction (V) as it moves between said first and said second positions and vice versa.

29. Dispenser (1, 1″) according to claim 28, wherein the tubular shell (55, 55″, 55′″) is preferably cylindrical and the directrix thereof is inclined relative to the washing agent drop direction (V) when the dispenser is in the operating condition, and wherein the bottom surface (51, 51″, 51′″) and the top surface (52, 52″, 52′″) of the movable chamber (5, 5″, 5′″) are at least partly integral with the shell (55, 55″, 55′″).

30. Dispenser (1′, 1*′) according to claim 18, wherein, when the dispenser is in the operating condition, the movable chamber (5′, 5*, 5̂) translates along an axis which is substantially perpendicular to the washing agent drop direction (V) as it moves between said first and said second position and vice versa.

31. Dispenser (1′, 1*) according to claim 30, wherein the tubular shell (55′, 55*, 55̂) is preferably cylindrical and the directrix thereof is substantially horizontal when the dispenser (1′, 1*) is in the operating condition, and wherein the bottom surface (51′, 51*, 51̂) and the top surface (52′, 52*, 52̂) of the movable chamber (5′, 5*, 5̂) are at least partly integral with the metering piston (59′,59*, 59̂) and follow the movements thereof.

32. Dispenser (1, 1′, 1″, 1*) according to claim 18, wherein the movable chamber (5, 5′, 5″, 5*, 5̂, 5′″) has predefined volume characteristics.

33. Washing machine, such as a laundry washing machine, a dishwasher or the like, characterized by comprising a dispenser (1, 1′, 1″, 1*) according to claim 18.

34. Method for supplying and discharging a washing agent through a dispenser (1, 1′, 1″, 1*) comprising at least one casing (3, 3′, 3″, 3*), which comprises at least one washing agent reservoir (6, 6′, 6″, 6*), and one metering element provided with at least one movable chamber that can be moved between a first and a second position respectively corresponding to a supply condition, wherein the washing agents (2, 2′, 2″, 2*) are supplied, preferably by gravity, from the reservoir (6, 6′, 6″, 6*) into the movable chamber through an inlet (7B, 7B′, 7B″, 7B*, 7B̂, 7B′″), and a discharge condition, wherein the washing agents (2, 2′, 2″, 2*) are discharged, preferably by gravity, from the movable chamber into the tub through a drain (4B, 4B′, 4B″, 4B*, 4B̂, 4B′″),
characterized in that
said method comprises at least the step of expelling the air accumulated in said movable chamber (5, 5′, 5″, 5*, 5̂, 5′″) into said reservoir (6, 6′, 6″, 6*) as the washing agent is being discharged, said air flowing up along the sliding surface (52, 52′, 52″, 52*, 52̂, 52′″), which is at least partly inclined relative to the washing agent drop direction (V) in an operating condition of the dispenser (1, 1′, 1″, 1*).
